(19) United States
(12) Patent Application Publication
(10) Pub. No.: US 2006/0146550 A1
(43) Pub. Date: Jul. 6, 2006

(54) Fixture-holding component, light fixture and pole light including the same

(76) Inventors: Charlie L. Simpson, Brampton, CA (US); Frank Cesario, Richmond Hill, CA (US)

Correspondence Address: GIFFORD, KRASS, GROH, SPRINKLE & CITKOWSKI, P.C, PO BOX 7021, TROY, MI, 48007-7021, US

(21) Appl. No.: 11/027,806

(22) Filed: Dec. 30, 2004

(51) Int. Cl. F21S 6/00

(52) U.S. Cl. 362/431

(57) ABSTRACT

Disclosed is a pole light including a base, a light fixture and a fixture-holding component. The base is for disposition on the ground. The light fixture includes a body, a plug component secured to the body and an electric lamp secured to the body and coupled to the plug component to receive electrical power delivered thereto. The fixture-holding component includes a stanchion and an electrical conductor. The stanchion has a base end and a top end, the base end being secured to the base such that the stanchion extends upwardly when the base is disposed on the ground, and the top end being releasably secured to and supporting the light fixture. The electrical conductor extends from the stanchion, adjacent the top end, and terminates in a first plug component releasably mated with the plug component of the light fixture for delivering electrical power thereto.

### FIELD OF THE INVENTION

The present invention relates to the field of event lighting, and more particularly, to pole lights for use in trade show environments.

### BACKGROUND OF THE INVENTION

Pole lights are widely used at trade shows. Such lights typically include a base and an upright stanchion extending from the base to a light fixture. Often, a variety of pole lights are made available for rental by operators of trade show facilities. This provides added revenue to the facility, but this revenue comes with a cost, as it requires an inventory of various types of lights to be stored, to meet the desires of the varied exhibitors. It is known to provide pole lights with flexibility. For example, U.S. Pat. No. 4,523,256 (Small), issued Jun. 11, 1985, teaches a pole light having a stanchion-mounted receptacle, and a light support arm to which up to four light fixtures can be attached, each light fixture including a coiled wire terminating in a plug for engaging the receptacle. However, the coiled wires detract from the aesthetics of the lamp, and this type of lamp is therefore limited in terms of consumer acceptance.

### SUMMARY OF THE INVENTION

A fixture-holding component forms one aspect of the invention. The fixture-holding component is for use with a base and with a light fixture to form a pole light, and comprises a stanchion and an electrical conductor. The stanchion has a base end and a top end. The base end is secured in use to said base such that the stanchion extends upwardly when said base is disposed on the ground. The top end, in use, is secured to and supports said light fixture. The electrical conductor is for providing electricity to said light fixture in use, extends from the stanchion, adjacent the top end, and terminates in a first plug component.

A light fixture forms another aspect of the invention. The light fixture is for use with a base and a stanchion secured to the base to extend upwardly when the base is disposed on the ground. The light fixture comprises a body, a plug component and an electric lamp. The body is adapted to be supported in use by said stanchion. The plug component is secured to the body. The electric lamp is secured to the body and coupled to the plug component to receive electrical power delivered thereto.

A pole light forms another aspect of the invention, and comprises a base, a light fixture and a fixture-holding component. The base is for disposition on the ground. The light fixture includes a body, a plug component secured to the body and an electric lamp secured to the body and coupled to the plug component to receive electrical power delivered thereto. The fixture-holding component includes a stanchion and an electric conductor. The stanchion has a base end and a top end, the base end being secured to the base such that the stanchion extends upwardly when the base is disposed on the ground, and the top end being releasably secured to and supporting the light fixture. The electrical conductor extends from the stanchion, adjacent the top end, and terminates in a first plug component releasably mated with the plug component of the light fixture for delivering electrical power thereto.

Advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 is a perspective view of a pole light constructed according to a first preferred embodiment of the present invention;

FIG. 2 is top plan view of the structure of FIG. 1;

FIG. 3 is a side elevational view of the structure of FIG. 1;

FIG. 4 is a front, elevational, partially broken-away view of the structure of FIG. 1;

FIG. 5 is an exploded perspective view of the structure of FIG. 1;

FIG. 6 is a bottom view of the structure in area 6 of FIG. 5;

FIG. 7 is a perspective view of a light fixture constructed according to a second preferred embodiment of the present invention;

FIG. 8 is a perspective view of a light fixture constructed according to a third preferred embodiment of the present invention;

FIG. 9 is a perspective view of a light fixture constructed according to a fourth preferred embodiment of the present invention;

FIG. 10 is a perspective view of a light fixture constructed according to a fifth preferred embodiment of the present invention;

FIG. 11 is a perspective view of a light fixture constructed according to a sixth preferred embodiment of the present invention; and

FIG. 12 is a perspective view of a light fixture constructed according to a seventh preferred embodiment of the present invention.

### DETAILED DESCRIPTION

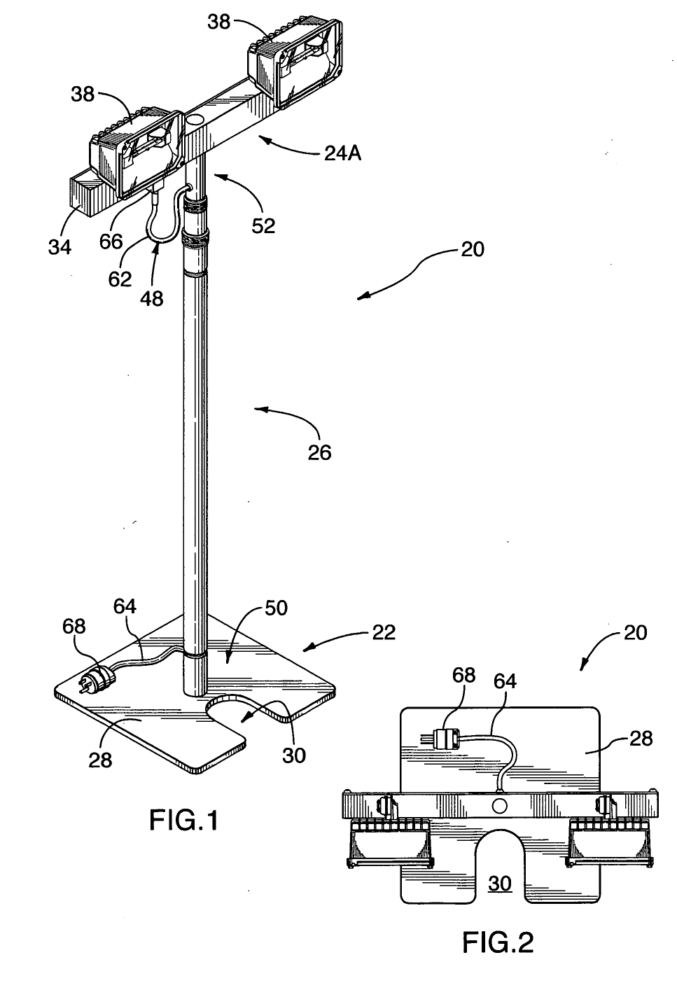

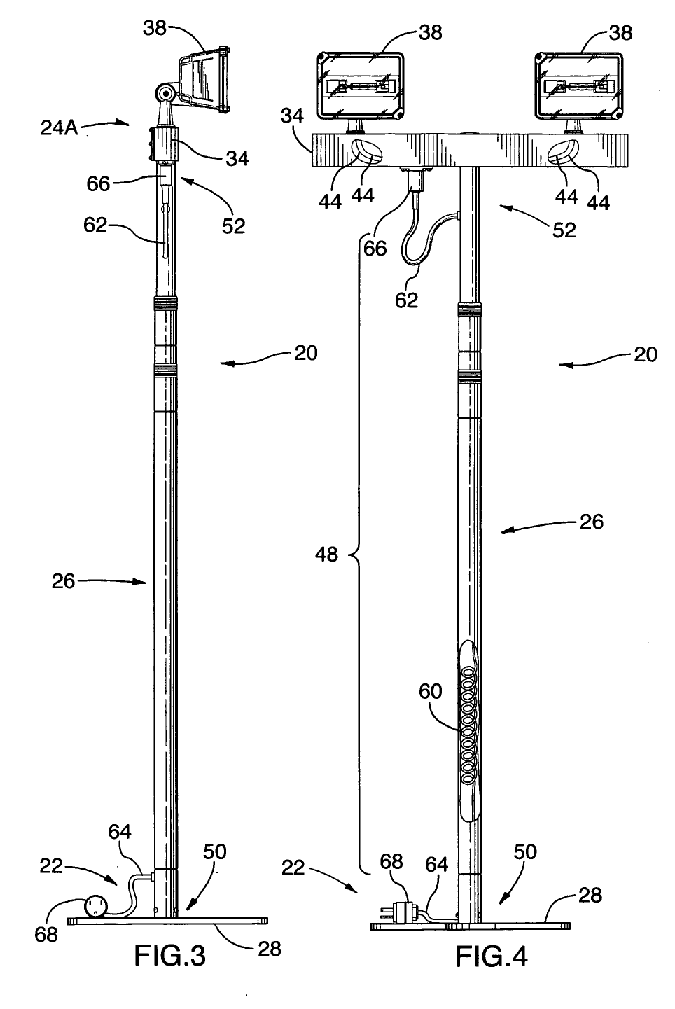

With reference to FIGS. 1-5, a pole light 20 according to a preferred embodiment of the present invention is illustrated, and will be understood to comprise a base 22, a light fixture 24A and a fixture-holding component 26.

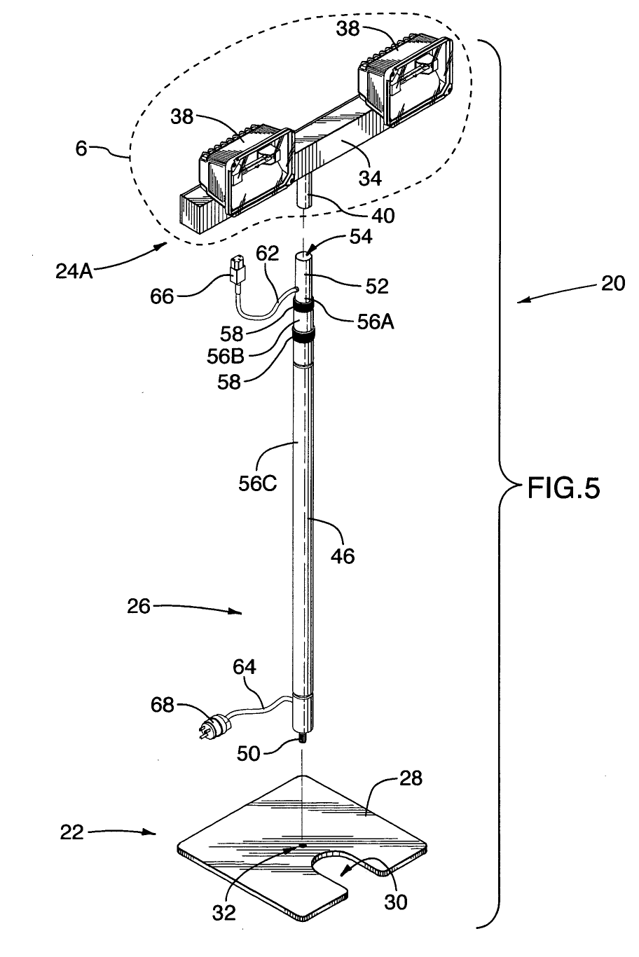

As best seen in FIG. 5, the base 22 is for disposition on the ground and in the preferred embodiment illustrated takes the form of a steel plate 28, provided with a suitable notch 30 to fit around drape poles (not shown) used by the exhibitors in a trade show. A threaded bore 32 is provided centrally in the base 22.

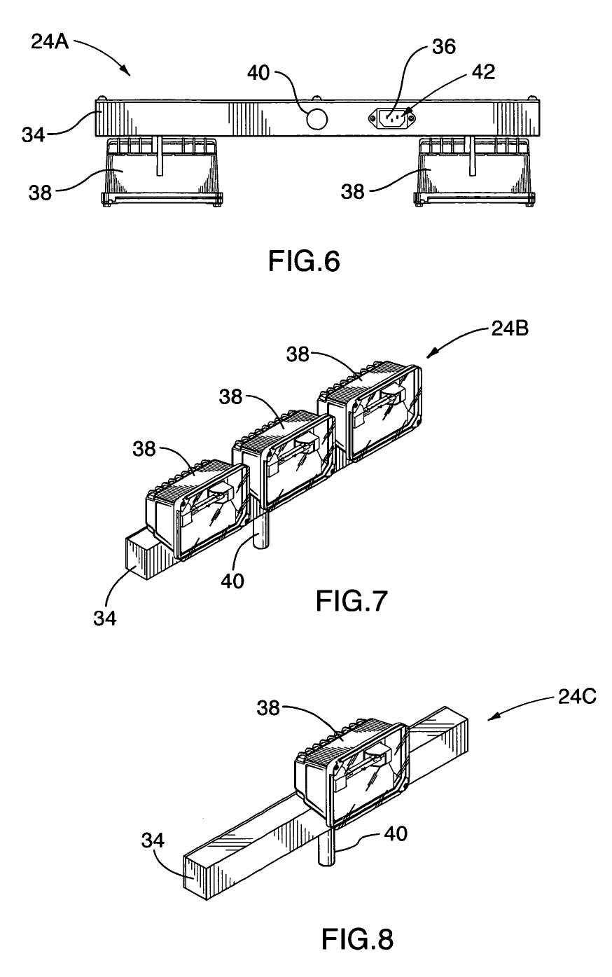

As best seen in FIGS. 4, 5, 6 the light fixture 24A includes a body 34, a male plug component 36 and a pair of electric lamps 38. The body 34 comprises a pin 40 and defines a recess 42. The plug component 36 is disposed in the recess 42 and secured to the body 34. The electric lamps 38 are of the quartz halogen type, and are secured to the body 34 and coupled to the plug component 36 to receive electrical power delivered thereto. In FIG. 4, the body 34 is shown partially broken away, to reveal conductors 44 which provide for such coupling of the lamps 38 and plug 36.

As best seen in FIGS. 1, 4, 5, the fixture-holding component 26 includes a stanchion 46 and an electrical conductor 48.

The stanchion 46 is telescopic, and has a base end 50 and a top end 52. The base end 50 is a threaded post, and, in the pole light 20, is releasably engaged in the threaded bore 32 provided in the base 22 such that the stanchion 46 extends upwardly when the base 22 is disposed on the ground. The top end 52 is a tube, and defines internally a socket 54 which receives the pin 40 of the body 34 to provide for releasable securement and support of the light fixture 24A. The telescopic nature of the stanchion 46 provides for height adjustment of the light fixture. Such telescopic functionality is provided in the preferred embodiment by constructing the stanchion 46 out of three concentric tubes 56A,56B,56C, securable to one another by knurled collars 58.

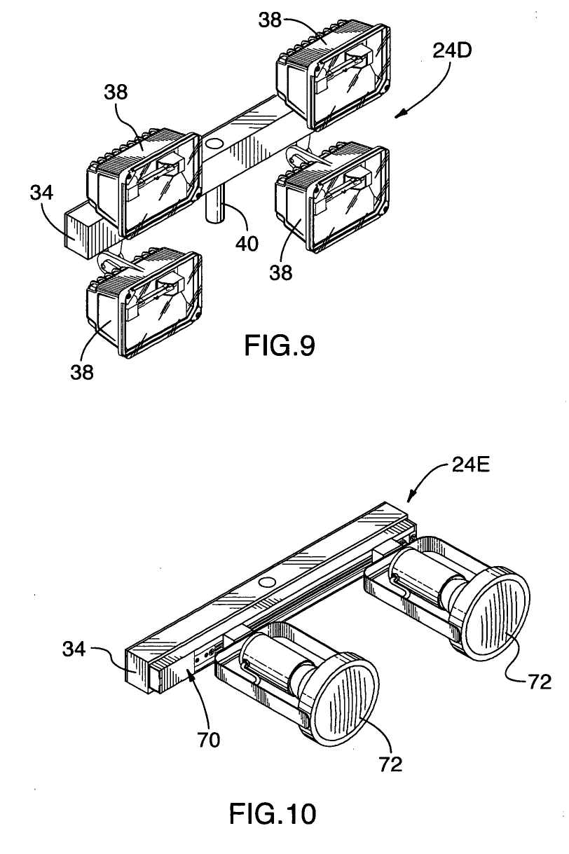

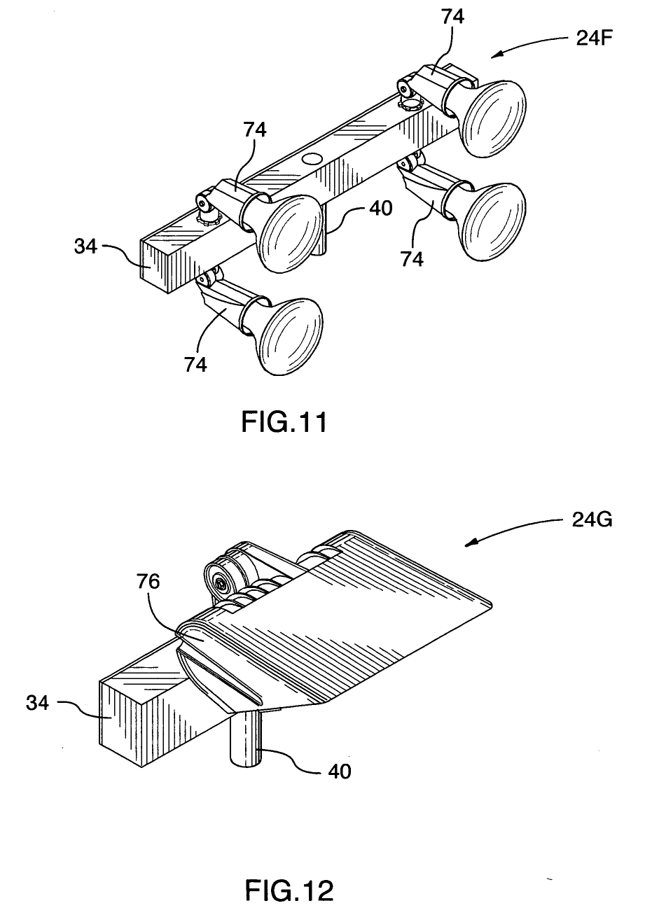

The electrical conductor 48 has a coiled central portion 60 disposed within the stanchion 46, as shown in FIG. 4, wherein portions of the stanchion 46 are shown broken away, and ends 62,64 extending from the stanchion 46, respectively, adjacent the top end 52 and the base end 50. The end 62 of the electrical conductor 48 extending from the stanchion 46 adjacent the top end 52 terminates in a female first plug component 66 and the end 64 of the electrical conductor 48 extending from the stanchion 46 adjacent the base end 50 terminates in a male second plug component 68. The male second plug component 68 is a conventional electrical plug, adapted to engage a conventional wall outlet (not shown), to receive electrical power. The female first plug component 66 is adapted to releasably mate with the male plug component 36 of the light fixture 24A and deliver electrical power received from the wall outlet or the like to the light fixture 24A. When the first plug component 66 of the light fixture holding component 26 is mated with the plug component 36 of the light fixture 24A, said first plug component 66 is disposed in close-fitting relation in the recess 42.

Whereas the light fixture 24A of the preferred embodiment is of a specific type including a pair of quartz halogen electric lamps 38, it should be understood that various modifications in this regard are possible. For example, the modified fixture 24B shown in FIG. 7, incorporates three quartz halogen lamps 38; the modified fixture 24C shown in FIG. 8 includes one quartz halogen lamp 38; and the modified fixture 24D shown in FIG. 9 comprises four quartz halogen lamps 38. Further, track style lighting can be provided, as shown in FIG. 10, which shows modified fixture 24E which includes a track 70 mounted to the body 34, and a pair of track-mountable spotlights 72 secured in the track 70. Further, incandescent lighting can be provided, as shown in FIG. 11, wherein four incandescent spotlights 74 are provided in modified fixture 24F. As well, task lighting can be provided, as shown in FIG. 12, wherein a task light 76 is shown in a modified fixture 24G. As will be readily understood by persons of ordinary skill in the art, the foregoing permits a wide variety of pole lights (not shown) to be constructed from a single inventory of fixture-holding components 26 and a variety of light fixtures 24A,24B,24C,24D,24E,24F,24G.

The interchangeable nature of the light fixtures 24A, 24B, 24C, 24D, 24E, 24F, 24G, all powered with a single plug that fits into a receptacle in the light fixture, provides a neat appearance to the pole light, with commensurate benefits in terms of consumer acceptance. When not in use, the light fixture 24A can be removed from the fixture-holding component 26, the fixture-holding component can be collapsed and removed from the base 22, and the various components compactly stored.

Other modifications are also possible, without departing from the spirit or scope of the invention. For example, whereas in the preferred embodiment illustrated, the end of the electrical conductor extending from the stanchion adjacent the top end terminates in a female first plug component, this need not be the case; this end could equally terminate in a male first plug component, and could mate with a female plug component provided in the light fixture. Further, whereas the stanchion of the preferred embodiment threads into the base, other arrangements could be provided; the base, for example, could be provided with a pin, and the base end of the stanchion could terminate in a tube defining a socket to receive such pin. Yet further, whereas the stanchion of the preferred embodiment shown is telescopic, this again, need not be the case; a stanchion of fixed length could readily be utilized. Accordingly, the invention should be understood as being limited only by the claims appended hereto, purposively construed.

1. A fixture-holding component for use with a base and with a light fixture to form a pole light, the fixture-holding component comprising:
a stanchion having a base end and a top end
the base end being secured in use to said base such that the stanchion extends upwardly when said base is disposed on the ground, and
the top end, in use, being secured to and supporting said light fixture; and
an electrical conductor for providing electricity to said light fixture in use, the conductor extending from the stanchion, adjacent the top end, and terminating in a first plug component.

2. A fixture-holding component according to claim 1, wherein the top end of the stanchion is a tube.

3. A fixture-holding component according to claim 1, wherein the base end of the stanchion is a threaded post.

4. A fixture-holding component according to claim 1, wherein the stanchion is telescopic.

5. A fixture-holding component according to claim 1, wherein the first plug component is a female plug component.

6. A fixture-holding component according to claim 1, wherein the electrical conductor has a coiled central portion disposed within the stanchion and ends extending from the stanchion, respectively, adjacent the top end and the base end, the end of the electrical extending from the stanchion adjacent the top end terminating in the first plug component and the end of the electrical conductor extending from the stanchion adjacent the base end terminating in a second plug component, the second plug component being male.

7. A light fixture for use with a base and a stanchion secured to the base to extend upwardly when the base is disposed on the ground, the light fixture comprising:
a body adapted to be supported in use by said stanchion;
a plug component secured to the body; and
an electric lamp secured to the body and coupled to the plug component to receive electrical power delivered thereto.

8. A light fixture according to claim 7, wherein the plug component is a male plug component.

9. A light fixture according to claim 7, wherein the body defines a recess, and wherein the plug component is disposed in the recess.

10. A light fixture according to claim 7, wherein the body comprises a pin, the pin being engaged by the stanchion in use to support the body.

11. A pole light comprising:
a base for disposition on the ground;
a light fixture including
a body;
a plug component secured to the body; and
an electric lamp secured to the body and coupled to the plug component to receive electrical power delivered thereto;
a fixture-holding component including
a stanchion having a base end and a top end
the base end being secured to the base such that the stanchion extends upwardly when the base is disposed on the ground, and
the top end being releasably secured to and supporting the light fixture; and
an electrical conductor extending from the stanchion, adjacent the top end, and terminating in a first plug component releasably mated with the plug component of the light fixture for delivering electrical power thereto.

12. A pole light according to claim 11, wherein the top end of the stanchion is a tube.

13. A pole light according to claim 12, wherein the body comprises a pin engaged in the tube forming the top end of the stanchion, to provide for said releasable securement.

14. A pole light according to claim 11, wherein the base end of the stanchion is releasably secured to the base.

15. A pole light according to claim 14, wherein the base end of the stanchion is threaded to the base.

16. A pole light according to claim 11, wherein the stanchion is telescopic.

17. A pole light according to claim 11, wherein the electrical conductor has a coiled central portion disposed within the stanchion and ends extending from the stanchion, respectively, adjacent the top end and the base end, the end of the electrical conductor extending from the stanchion adjacent the top end terminating in the first plug component and the end of the electrical conductor extending from the stanchion adjacent the base end terminating in a second plug component, the second plug component being male.

18. A pole light according to claim 11, wherein the plug component of the light fixture is a male plug component.

19. A pole light according to claim 11, wherein the body defines a recess, and wherein the plug component of the light fixture is disposed in the recess.

20. A pole light according to claim 19, wherein, when the first plug component of the fixture-holding component is mated with the plug component of the light fixture, said first plug component is disposed in close-fitting relation in the recess.
